(19) United States
(12) Patent Application Publication
(10) Pub. No.: US 2015/0310044 A1
(43) Pub. Date: Oct. 29, 2015

(54) DATABASE DEVICE AND PROCESSING OF DATA IN A DATABASE

(71) Applicant: CodeFutures Corporation, Broomfield, CO (US)

(72) Inventors: Cory M. Isaacson, Broomfield, CO (US); Andrew F. Grove, Broomfield, CO (US)

(21) Appl. No.: 14/704,821

(22) Filed: May 5, 2015

Related U.S. Application Data
(63) Continuation-in-part of application No. 14/613,356, filed on Feb. 3, 2015.
(60) Provisional application No. 61/988,861, filed on May 5, 2014.
(60) Provisional application No. 61/935,301, filed on Feb. 3, 2014.

(51) Int. Cl. G06F 17/30

(52) U.S. Cl. CPC G06F 17/30292; G06F 17/30554; G06F 17/30581; G06F 17/30578; G06F 17/30321; G06F 17/30864; G06F 17/30595; G06F 17/30368

(57) ABSTRACT

Implementations of database systems and methods of processing database data are provided. For example, a method includes: transforming data from one or more source databases into at least one stream of data; coupling the at least one stream of data to at least one stream processing node for processing; and processing the at least one stream of data at the at least one stream processing nodes. Another method includes: writing a record to a database in an append-only log file; indexing the append-only log file; referencing a history of at least one version of an index structure, such as a key, if the record exists in the database with the same index structure; look up the record in the database by index structure of the append-only log file; and exposing an ordered queue including an order in which transactions were written in addition to using an index structure look up.

### CROSS-REFERENCE TO RELATED APPLICATIONS

This application claims the benefit of U.S. provisional patent application No. 61/988,861 entitled “Database Device and Processing of Data in a Database” and filed on May 5, 2014, which is hereby incorporated by reference in its entirety as if fully set forth herein.

This application is also a continuation-in-part of U.S. patent application Ser. No. 14/613,356 entitled “Dynamic Modification of a Database Data Structure” and filed on Feb. 3, 2015, which claims the benefit of U.S. provisional application No. 61/935,301 entitled “Dynamic Modification of a Database Structure” and filed Feb. 3, 2014, each of which is hereby incorporated by reference as though fully set forth herein.

### BACKGROUND

a. Field

The instant invention relates to database systems and methods of processing database data.

b. Background

FIG. 1 shows an example existing database system 10 including an application client 12 and a database 14. The database 14 includes a fixed schema static repository in which a sharded database is organized by a fixed key (e.g., by player). During operation, the application client 12 reads data from and writes data to the database 14. In addition, data can be pulled from the database 14 for processing, such as by one or more processors 16 and processing results re-written into the database 14. As more and more data is written to the database 14, the sharded database may become overloaded and/or data relationships change or different relationships requested by the application client than the fixed key by which the database 14 is sharded. Schema changes that are necessary for re-organizing the structure of the database are not performed in real-time, take a lot of time and processing away from database operation and can quickly degrade the performance of the database 14. The typical process requires a programmer to write data to a database, read back the data, potentially in a different form, perform some processing on the data, then write the data to the database in the same form or a different form. This is a very cumbersome back-and-forth task requiring a lot of programmatic code, detailed understanding by the developer, and rarely does the data structure match the application needs. Thus developers are forced to attempt cumbersome manipulations of data into and out of the fixed schema, often with extremely poor performance.

In other instances, different types of databases are required to match application needs. For example, an in-memory database may be needed for fast access to specific data. This requires the application developer to write program code to input data into two or more databases, attempting to keep data in sync. Then subsequently data must be retrieved from the potential plurality of database types to access the data in the most efficient way. This again requires a lot of programmatic work, and the application developer must understand each type of database engine, how it is used, and define specific fixed data structures for each.

In other implementations developers need to use complex, cumbersome and slow extract/transform/load processes between source and target databases, or even within a single database.

In yet other prior implementations, database views are supported within a single database engine. These can be used to generate custom data structures, but perform slowly and burden the entire database since they are performed in a single database.

The foregoing and other aspects, features, details, utilities, and advantages of the present invention will be apparent from reading the following description and claims, and from reviewing the accompanying drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a block diagram of an example database system;

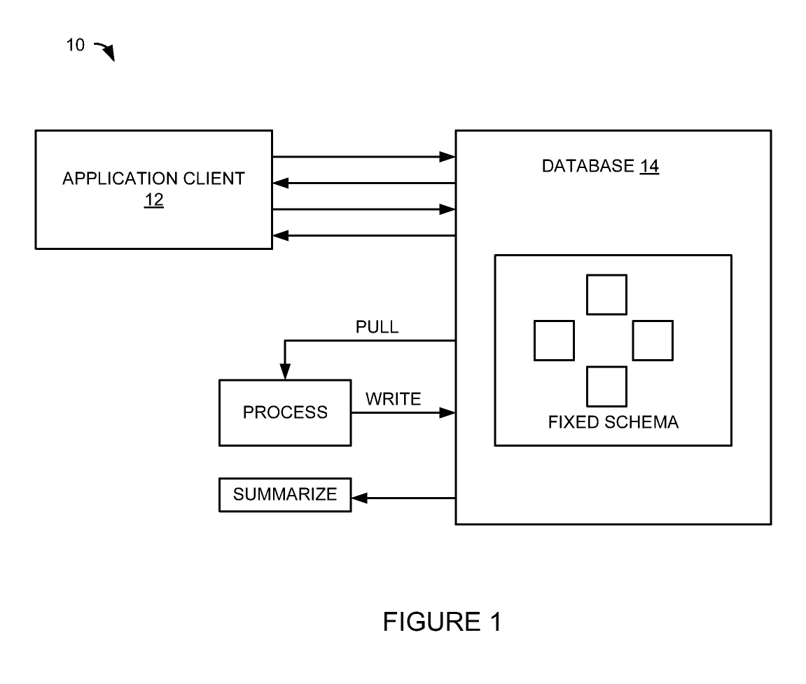

FIG. 2 is a block diagram of an example database system;

FIG. 3 shows a table of a database data structure and database changed records for an example database;

FIG. 4 shows example operations of a process for creating/updating a database data structure such as the example structure shown in FIG. 3;

FIG. 5 shows another flow diagram showing example operations performed within databases system including stream processing as described above with respect to FIG. 2;

FIG. 6 shows another implementation of a database device, such as described above with reference to FIGS. 2 and 3, implemented on a hardware device including non-volatile data storage components;

FIG. 7 is a block diagram of an example implementation of a sharded database system, such as may be used in an evolutionary or responsive database system as described herein;

FIG. 8 is a block diagram of another example of a sharded database system including a sharded database cluster system as described herein;

FIG. 9 is a block diagram of an example database stream in which one or more database commands are received from a client application and analyzed at a database as described herein;

FIG. 10 is a block diagram showing another example of a sharded database system in which database query commands from the client are directly provided to a database and/or to a stream view generated synchronously and/or asynchronously from the database as described herein;

FIG. 11 is a block diagram showing an example implementation of a stream engine that monitors and analyzes one or more database commands of a database as discussed herein;

FIG. 12 is a block diagram showing yet another example implementation of a database system in which one or more log files provide a database stream for analysis as described herein;

FIG. 13 is a flow chart showing an example process of dynamically monitoring operation of a database system and modifying data structures or suggesting modifications of data structures in the database in response to database commands, such as queries, received at the database from a client as described herein;

FIG. 14 is a block diagram illustrating example functions applied to data in a stream. In this example implementation, for example, a viewer Viewdb provides continuously updated snapshots of the updated stream output of the functions as described herein;

FIG. 15 is a block diagram illustrating an example pluggable view engine Viewdb that may be used to provide one or more snapshots of a database stream as described herein;

FIG. 16 is a block diagram illustrating an example implementation of a shard stripe approach as described herein; and

FIG. 17 is a block diagram illustrating an example computing device on which one or more database storage elements (e.g., database shards of a sharded database) may reside in whole or in part.

### DETAILED DESCRIPTION

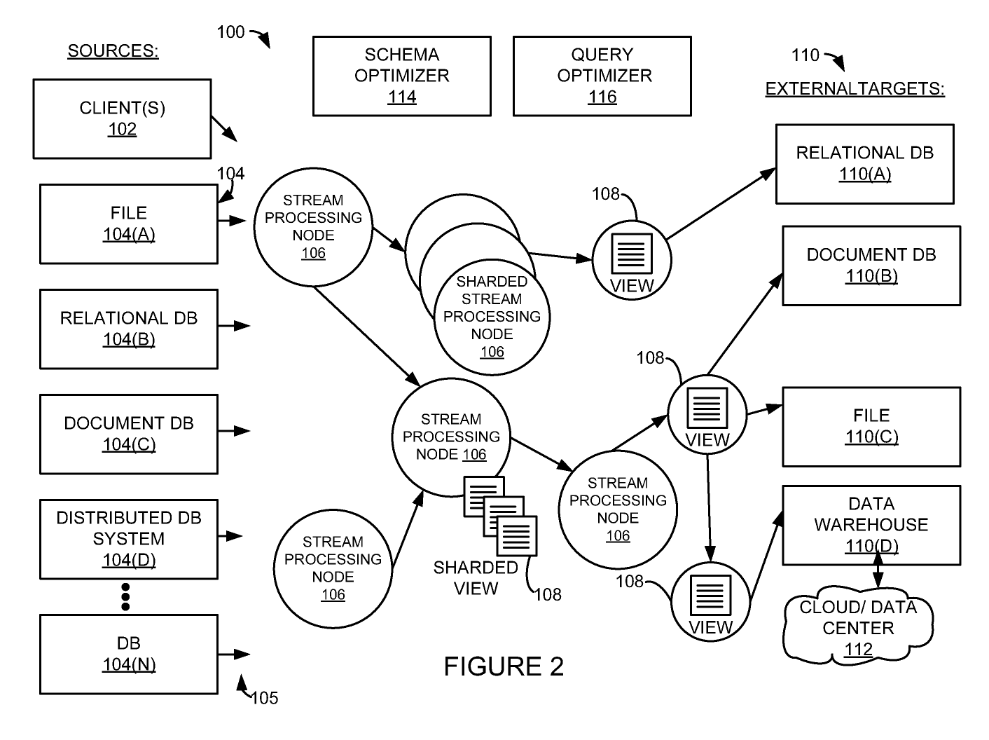

FIG. 2 shows an example database system 100. In this implementation, the database system 100 includes sources such as one or more application clients 102 and/or one or more source databases 104(A), 104(B) . . . 104(N). Each of the source databases 104, for example, may comprise any type of database or transaction log (change control log) for any type of database. In the particular implementation shown in FIG. 2, for example, the sources include an application client 102 and a plurality of source databases 104(1) through 104(N) including a file source database 104(A), such as a delimited data file, or a transaction log (change control log) file for a database (e.g., a MySQL binary log), a relational database 104(B) (e.g., a MySQL database), a document database 104(C) (e.g., a Mongo database), a distributed database system 104(D) (e.g., Cassandra database) and any other type of source database.

Outputs from the one or more application client(s) 102 and the one or more source databases or files 104 are transformed (by pull or push) into a stream of data 105, optionally grouped into one or more transactions. Transactions are supported across one or more databases or partitions, guaranteeing that the entire transaction succeeds or fails as an atomic operation. The stream 105 is then coupled to one or more stream processing nodes for subsequent processing 106. The stream processing nodes 106 process data from the one or more source database streams 105 and, optionally, store one or more processing results in a database view 108. The stream processing nodes 106 may, for example, be arranged in any manner and may perform any data processing on data received from the one or more application clients 102 and/or the one or more source databases 104.

In this particular implementation, the database system 500 further includes a schema optimizer 114 and a query optimizer 116. The optimizers 114, 116 are used as either a Query Optimizer, to decide which View to use (e.g., the best or relatively better) as a source of data for a query, and/or a Schema Optimizer to identify and recommend View schemas to match application needs. Examples of Query and Schema Optimizers 114, 116 are further described below.

In one implementation of the database system of FIG. 2, the views 108 comprise persistent and query-able dynamic schemas of the data derived or transformed from the stream generated by more of the source databases. The views 108 may, for example, comprises database views of data from one or more of the source database streams 104 organized by a different key value or other structure than the source database or data, may comprise results of processing operations performed on data from one or more of the source databases 104 (e.g., summarized data, averaged data or the like, filtered data, or enriched data as joined with data from other stream sources or views).

In various implementations, such as the one shown in FIG. 2, the database system 100 may further include external database targets 110. In the particular implementation of FIG. 2, for example, the external database targets include an external relational database target 110(A) (e.g., a MySQL external database target), an external document database target 110(B) (e.g., a Mongo external database target), a file external database target 110(C) (e.g., a delimited data file) and a data warehouse external database target 110(D) (e.g., a Google BigQuery data warehouse). In this implementation, data, whether from one or more of the source database streams 105 and/or the result of one or more processing streams 108, may be returned to one or more of the application clients 102, one or more of the source databases 104, stored in one or more database views 108 and/or transmitted to one or more of the external database targets 110 for storage.

Any of the databases of the databases system 100 may comprise sharded or unsharded databases. Streams can be sharded to improve parallel distributed processing performance, with each Stream processing node handling a subset of the stream data based on a shard key. Views can also be sharded together with or separate from the stream sharding; in the case where a View is sharded together with a stream using the same shard key, high performance local access from the stream to the view is supported, avoiding network delays to retrieve data from other servers on the network. Target external databases can also be sharded.

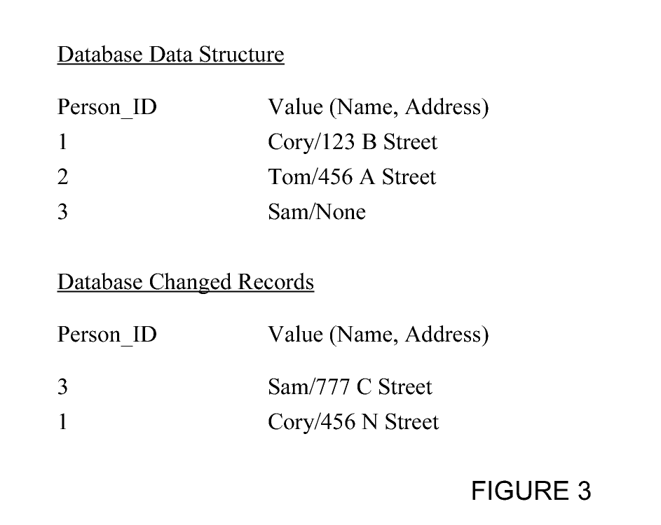

FIG. 3 shows an example simplified database data structure for a database organized in a key-value format and a changed records of the database data structure after a database write command is performed. In this example, the database data structure comprises a plurality of key values (Person_ID) and a plurality of values (Name, Address).

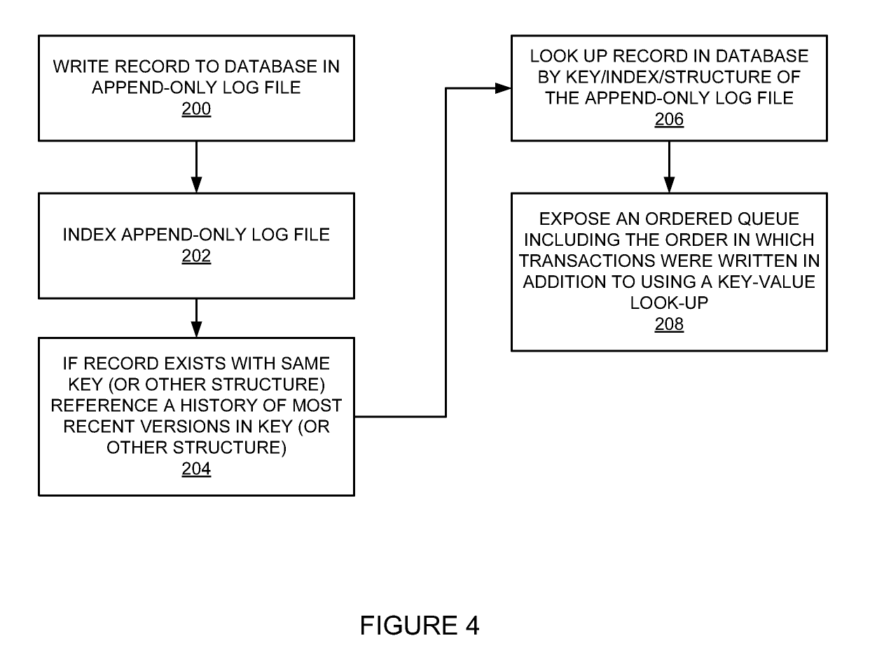

FIG. 4 shows example operations of a process for creating/updating a database data structure such as the example structure shown in FIG. 3. In operation 200, for example, a database record is written to a database in an append-only log file. In this implementation, the write to the append-only log file is a sequential write to a disk or other storage medium and is relatively fast compared to a non-sequential write operation. The append-only log file is indexed in operation 202 for the record in a Key index or other data structure as required to meet application needs. If a record already exists in the database with the same primary key, a history of the most recent versions is referenced in the key, storing the location of the current and prior version(s) in the append-only log in operation 204. For example, the position in the append-only log file is stored for the most recent version and a number of prior changes can also be stored for comparison or audit trail purposes.

Any record in the database can be looked up by the key index in operation 206, or by any custom index or other data structure to enable navigation of the append-only log. The key index or other structure is used to find the position of the record in the append-only log file to look up the record.

In operation 208, an ordered queue including the order in which transactions were written is exposed in addition to using a key-value lookup as described in operation 206. A special client called a consumer can read data in order of operations using this facility. This allows for stream processing on changes to the database in the order performed. For example, the ordered queue exposed in operation 208 may be used to accumulate a sum of records (e.g., persons) located in a particular geographic region. In another implementation, another database may be constructed as a view of a first database, sorted by a different key (e.g., city, state, etc.). The additional database can contain the entirety of the original (primary) database or can contain all or a portion of the information in the record of the original database, or can contain a manipulated, enriched or transformed version of the data in the original database. In another implementation, the database may be replicated to a copy for reliability, within a single transaction to ensure that no data is lost. These implementations, however, are merely examples of types of stream processing that may be performed on changes to the database. Other variations are contemplated.

The ordered queue enables synchronous processing with guaranteed transactions in the primary store and further enables downstream synchronous or asynchronous processing on a streaming basis, such as for real-time or near-real-time processing and manipulation of data. Thus databases may be chained together, building different view of the data in the downstream instances as a result of stream processing. Further the stream may also be used to trigger events, such as when a threshold is hit for some value. Since the databases all have access to one another, and to the streams, values can be joined together as needed during processing, from multiple streams and/or views providing a flexible database system.

In this implementation, at least two interfaces are provided for the system: (1) a key-value or sorted key query facility or custom structure to meet application needs and (2) a consumer client of the ordered sequence of the updates as a reliable queue. The interfaces are exposed together to provide for stream processing in the database. This provides multiple access paths to a single database store to an application developer or other components in the system, both in order of operation or by specific keys or data structures as needed.

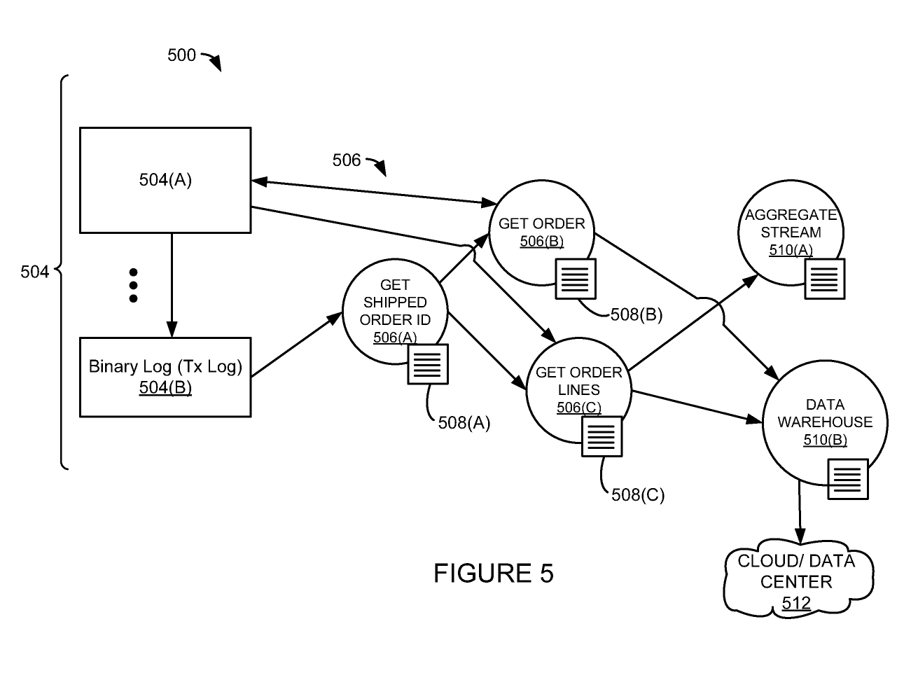

FIG. 5 shows another flow diagram showing example operations performed within a database system including stream processing as described above with respect to FIG. 2. In this particular implementation, for example, a database system 500 includes a relational source database 504(A) (e.g., a MySQL relational source database) and a binary log source database 504(B) (e.g., an append-only transaction log source database). Data from the source databases 504 is processed via a plurality of stream processing nodes 506 (506(A), 506(B), 506(C)). In the particular implementation shown in FIG. 5, for example, data from the binary log file source database 504(B) is received and processed at stream processing node 506(A). In this case, stream processing node 506(A) reads a “Shipped Order ID” value from the binary log file source database 504(B), such as via a fixed key of the database and creates a custom database view 508(A). The custom database view 508(A), for example, may comprise a persistent, query-able database view organized by a custom key, such as the “Shipped Order ID” value retrieved from the binary log file source database 504(B). The “Shipped Order ID” values are also forwarded (in real-time, near real-time or asynchronously) to processing stream nodes 506(B) and 506(C).

At stream processing node 506(B), the node reads an “Order” value from the relational database 504(A) for the “Shipped Order ID” received from stream processing node 506(A). The stream processing node 508(B) processes the data received from the stream processing node 506(A) and the relational source database 504(A) and creates a second database view 508(B). The second database view 508(B) may, for example, include a custom database view that is persistent and query-able organized by the “Shipped Order ID” key value. Similarly, stream processing node 506(C) also receives the “Shipped Order ID” value from the from the stream processing node 506(A) and reads “Order Lines” values from the relational source database 504(A) based on the “Shipped Order ID” value received from the stream processing node 506(A). The stream processing node 506(C) also creates a third database view 508(C). The third database view 508(C) may, for example, include a custom database view that is persistent and query-able organized by a “Shipped Order ID” key value.

The views for 508(B) and 508(C) can be read by a consumer to create a reliable relay stream to another data center or cloud environment 512, allowing data to be easily transported to remote locations or processing facilities. The stream processing nodes 506(B) and 506(C) may also write data to another view 510(A), such as an Aggregate Stream Database 510(A) and concurrently write to an external database such as a data warehouse external target 510(B). In one implementation, for example, the aggregate stream database 510(A) may include one or more summaries of records created by one or more of the stream processing nodes 506.

In one implementation, the database system 500 provides processing identifiers at one or more of the stream processing nodes to allow for consistent reads even in the event of asynchronous processing being performed by one or more of the stream processing nodes 506. In this implementation, for example, a timestamp, a general sequence ID or other identifier may be added to the processing results at each step to guarantee consistent reads of data throughout the system 500.

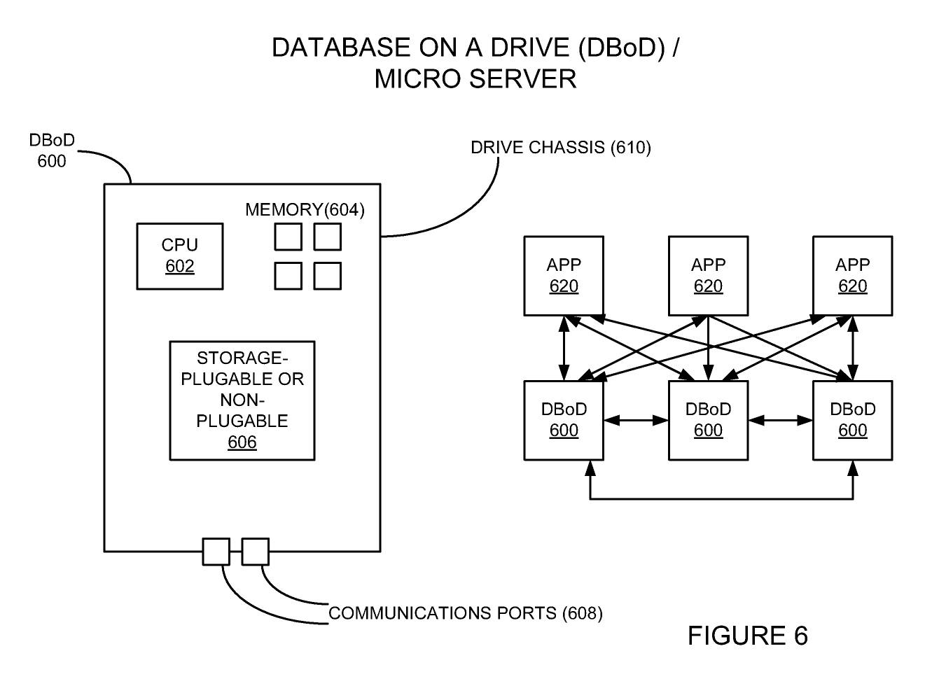

FIG. 6 shows another implementation of a database device 600, such as described above with reference to FIGS. 2 and 3, implemented on a hardware device including non-volatile data storage components, such as one or more of a hard disk, a flash drive, a flash chip, a RRAM chip or the like. In this particular implementation, for example, the database device includes a micro-server comprising a processor 602, memory 604 (e.g., volatile memory such as RAM memory), a communications port 608 (e.g., an Ethernet connector), and non-volatile data storage 606 (e.g., Flash data storage, MSATA Flash data storage, memory, RRAM, F-RAM, magnetic data storage, optical data storage, spinning disk drive storage). In one implementation, for example, the non-volatile storage may comprise a pluggable storage. The device can be networked to perform one or more distributed functions, such as described in U.S. patent application Ser. No. 14/613,356 entitled “Dynamic Modification of a Database Data Structure” and filed on Feb. 3, 2015 and U.S. provisional application No. 61/935,301 entitled “Dynamic Modification of a Database Structure” and filed Feb. 3, 2014, each of which is incorporated by reference in its entirety as though fully set forth herein.

As further shown in FIG. 6, a plurality of database devices 600 (e.g., a database on a drive (DboD)) may be coupled together, such as via one or more network communications ports. In one implementation, for example, a plurality of DboD's 600 are coupled to each other via a plurality of Ethernet connections via network communication ports 608 and further to one or more application clients 620 in a one-to-many or many-to-many configuration. Each of the DboD's 620 may communicate with each of the application clients 620 and each of the other DboD's 600.

Where append-only log files are used, for example, consumer-grade non-volatile data storage such as non-volatile Flash data storage may be used in one or more of the DboD's in a commercial application because the number of re-write cycles to the data storage is relatively minor/less than a corresponding system in which non-volatile data storage is repetitively re-written.

In one particular implementation, a custom high-level declarative definition language may be implemented for creating and managing processing streams within the database systems described herein. Use of such a language alleviates the need for a programmer to write custom complex code, reducing and simplifying the work required to create a stream flow and views. For example, the declarative definition language may comprise one or more statements for creating a stream from one or more sources (e.g., source files, databases, other streams, views or the like), creating a view (query-able or non-query-able), selecting one or more data structures for the view, and/or identifying an output external target for the process and/or view created.

One programming example for implementing the stream processing node 506(A) and view 508(A) shown and described above with reference to FIG. 5 is as follows:
MySQL Binlog to BigQuery SCL example
These streams run local to MySQL
Stream to detect SHIPPED orders from MySQL Binlog
CREATE STREAM s_mysql_shipped_order FOR mydomain
WITH
SOURCE FILE source_mysqlbinlog.myschema
VIEW
SELECT order_id AS shipped_order_id
FROM customer_order
WHERE new.order_status=‘SHIPPED’

In this example, a stream is first created via a “CREATE STREAM” command in which shipped orders from the binary log 504(B) are pulled to create the stream and the view 508(A) is created using shipped order IDs from customer orders.

Next, the “Get Order”stream processing node 506(B) and view 508(B) are implemented as follows:
Stream customer_order from source MySQL
CREATE STREAM s_order FOR mydomain
WITH
SOURCE STREAM s_mysql_shipped_order
SOURCE DBMS dbms_mysql.myschema
VIEW
SELECT order_id, order_date, customer_id, order_status, order_total
FROM customer_order
WHERE order_id=s_mysql_shipped_order.shipped_order_id

In this example, a stream for stream processing node 506(B) is created via the “CREATE STREAM” command in which shipped order IDs are received from stream processing node 506(A) and order data is retrieved from MySQL relational database 504(A). View 508(B) is created via “VIEW” command using the shipped order IDs and order data are stored as defined.

The “Get Order Lines”stream processing node 506(C) and view 508(C) are implemented as follows:
Stream customer_order_line from source MySQL
CREATE STREAM s_order_line FOR mydomain
WITH
SOURCE STREAM s_mysql_shipped_order
SOURCE DBMS dbms_mysql.myschema
VIEW
SELECT line_number, product_id, qty, unit_price, line_total
FROM customer_order_line
WHERE order_id=s_mysql_shipped_order.shipped_order_id

In this example, a stream for stream processing node 506(C) is created via the “CREATE STREAM” command in which shipped order IDs are received from stream processing node 506(A) and order line data is retrieved from MySQL relational database 504(A). View 508(C) is created via “VIEW” command using the shipped order IDs and order line data are stored as defined.

In one implementation, a custom stream could be added here to purge one or more source databases.

Other processing including providing information to external targets, such as the aggregate stream 510(A) and view and the external data warehouse 510(B) may be implemented, such as by the following:
All subsequent streams run in Google Cloud
Real-time Aggregate Stream
CREATE STREAM s_order_stats_by_product FOR mydomain
WITH
SOURCE STREAM s_order_line
VIEW
SELECT TIME_DIM(order_date, INTERVAL 15 SECONDS AS 15_SECONDS,

INTERVAL 1 MINUTE AS 1_MINUTE)

AS order_date_dim,

product_id,

SUM(line_total)
FROM s_order_line
GROUP BY order_date_dim, product_id
Stream to BigQuery
CREATE STREAM s_mysql_to_bigquery FOR mydomain
WITH
SOURCE STREAM s_order, s_order_line
VIEW DBMS dbms_bigquery.mydataset.order_table
SELECT order_id, order_date, order_status, order_total
FROM s_order
NEST

(SELECT line_number, product_id qty, unit_price, line_total

FROM s_order_line

WHERE order_id=s_order.order_id)

### Example Optimizers

Optimizers (e.g., schema and query optimizers 114 and 116 shown in FIG. 2) may include a number of different optimizers. Query optimization, for example, has been performed in relational database systems. In these systems, a query optimizer attempts to determine an efficient way to execute a given query by executing a query plan to reduce the processing time of the query. The query plan is typically an automated process that attempts to optimize the query to reduce its processing time. The query plan can be determined based on statistics of the data in the database, using an algorithm to pick the optimum plan given a database structure previously defined by a user of the database system. The database structure is defined as a data model, comprised of a table or similar structure, optionally in conjunction with indexes to improve performance. In some example, a user of the database must understand application requirements in order to create such a structure, and when application requirements change over time, the structure can become inefficient or unable to meet the requirements in terms of functionality or performance.

In some implementations, a self-optimizing database machine is provided in which data structures are evolved (e.g., added, dropped and changed) and/or evolving data structures are suggested in response to database commands received from a client at a database. Further, algorithms may be pushed to one or more processors located at a drive and performed in parallel (e.g., via vector or other processing) to increase operational speed of a database. In one particular implementation, the new or modified database structures and/or algorithms may be compiled into object code (e.g., native low-level assembler code that can be run directly on the processor) to be executed on a processor co-located or embedded in a storage device. In another implementation the new or modified database structures and/or algorithms may be dynamically loaded into the chip pathways as custom gate arrays (e.g., in an FPGA) at a component of a database system (e.g., a processor co-located or embedded in a storage device storing a shard or a collection of micro-shards of a database).

In one implementation, a dynamic database system is provided including a non-transitory computer readable medium adapted for storing database data, wherein one or more data structures of the database or a stream view of the database is modified or created in response to monitoring database queries.

In various implementations, a self-optimizing database machine may be provided in which data structures are evolved (e.g., added, dropped and changed) in response to database commands received from a client at a database. Further, algorithms may be pushed to one or more processors located at a drive and performed in parallel (e.g., via vector or other processing) to increase operational speed of a database. In one particular implementation, the new or modified database structures and/or algorithms may be compiled into object code (e.g., native low-level assembler code that can be run directly on the processor) to be executed on a processor co-located or embedded in a storage device. In another implementation the new or modified database structures and/or algorithms may be dynamically loaded into the chip pathways as custom gate arrays (e.g., in an FPGA) at a component of a database system (e.g., a processor co-located or embedded in a storage device storing a shard or a collection of micro-shards of a database).

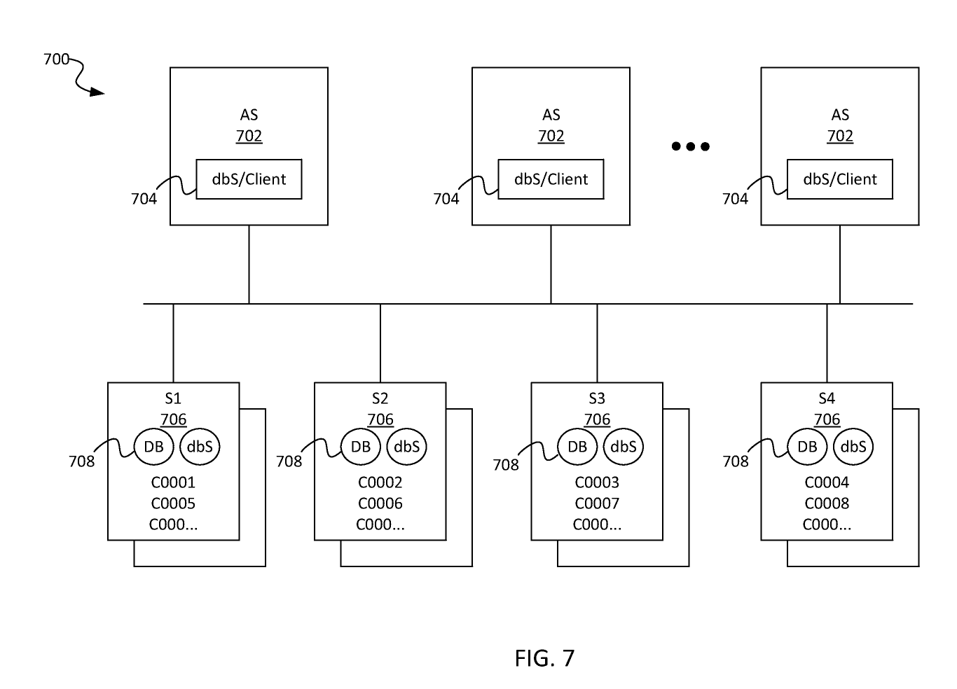

FIG. 7 shows an example implementation of a sharded database system 700, such as may be used in an evolutionary or responsive database system as described herein. It is important to note, however, that the sharded database system shown in FIG. 7 is merely one example database system. In the system shown in FIG. 7, a plurality of application servers (AS) 702 is configured supporting one or more database client module (dbS/Client) 704. The plurality of application servers (AS) 702 and, thus, the supported database client modules (dbS/Clients) 704 are coupled to a plurality of database shards (S1,S2,S3,S4, . . . Sn) 706 of a sharded database, such as, but not limited to, a sharded relational database. In the particular implementation shown in FIG. 7, for example, a first database shard S1 of a database (DB) 708 is sharded by a plurality of rows C0001, C0005, C0009, . . . ; a second database shard S2 of the database (DB) 708 is sharded by a second plurality of rows C0002, C0006, C0010 . . . ; a third database shard S3 of the database (DB) 708 is sharded by a third plurality of rows C0003, C0007, C0011, . . . ; and a fourth database shard S4 of the database (DB) 708 is sharded by a fourth plurality of rows, C0004, C0008, C0012, . . . . Again, the number of shards and rows within each shard is merely an example. Any number of sharding configurations may be used.

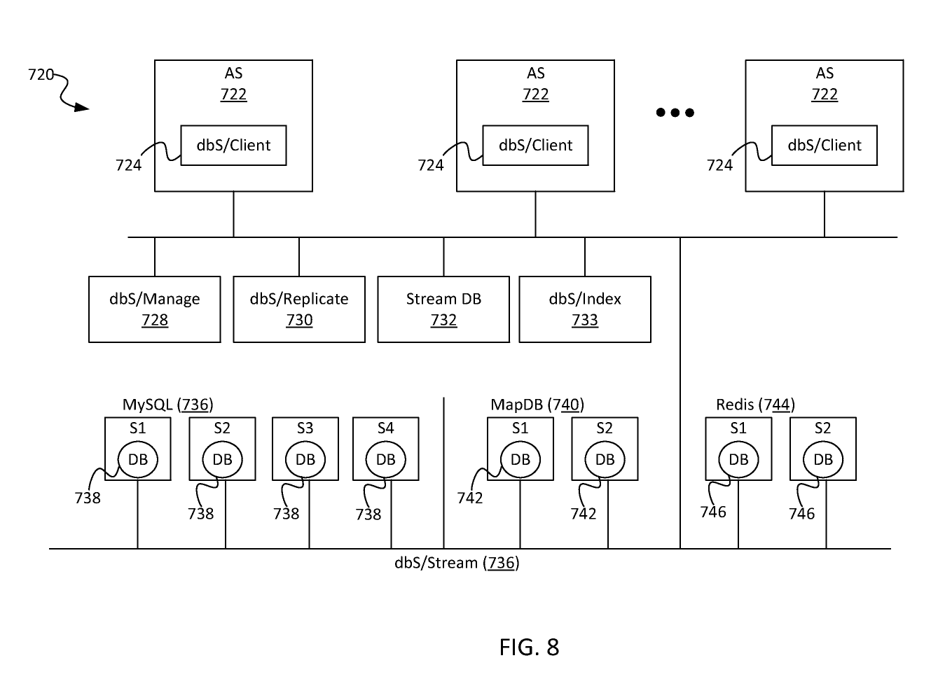

FIG. 8 shows another example of a sharded database system 720 in which the system comprises a sharded database cluster system. The example system shown in FIG. 2 again comprises a plurality of application servers (AS) 722 each supporting one or more database client module (dbs/Client) 724. The system further comprises a management Console 726, an administrative application connected to a management server (dbS/Manage) 728, which will be described in more detail herein. Each of the application servers 722 and, thus, the supported database client modules (dbS/Client) 724 are coupled to a database manager server (dbS/Manage) 728, a collection of one or more database replication servers (dbS/Replication) 730, a stream database server (dbS/StreamDB) 732 as well as a plurality of individually sharded databases 734. In various implementations, an indexing engine dbS/Index 733 (e.g., a third party indexing engine similar to Apache Lucene AL) may be used to populate and/or maintain an index.

In the particular example implementation shown in FIG. 8, for example, individually sharded databases comprise a MySQL database 736 comprising a plurality of database shards (S1,S2,S3,S4, . . . ) 738, a MapDB sharded database 740 comprising a plurality of database shards (S1,S2, . . . ) 742 and a Redis sharded database 744 comprising a plurality of database shards (S1,S2, . . . ) 746. These individual types of sharded databases are merely exemplary. As described above, each database may comprise any type of database including a sharded database (as shown), a relational sharded database, a micro sharded database, relational micro sharded database or the like. In one particular implementation, for example, one or more of the databases comprises an append-only log database.

In this implementation, the Manage server (dbS/Manage) 728 accumulates statistics on queries run against the database cluster 734, the statistics being collected by the Client (dbS/Client) 724 and/or by monitoring a database transaction log.

By analyzing the query statistics, the Manage server 728 may monitor for such things as repetitive or slow queries issued to one or more of the databases 734. Statistics such as measurement of repetitive or slow queries are then used to feed an algorithm, such as a heuristic algorithm, to generate or recommend database structures that best fit the query needs. In this implementation, the Manage server 728 will evaluate query patterns, query frequency, average execution time for a query pattern, maximum/minimum execution time for a query; any of these statistics may be used in determining the optimum storage structure for the data.

Where the database queries in the stream are not resolved or completed satisfactorily (e.g., within a predetermined time period, within a predetermined efficiency, etc.), the Manage server 728 can dynamically determine a new data structure for the database or for a stream view (e.g., StreamView) in order to provide a new data structure to optimize or otherwise improve the performance operation of the database query. The Manage server 728, for example, may dynamically determine and further dynamically change a data structure of a database and/or a stream view or dynamically create a new stream view to optimize or otherwise improve the operation of one or more database commands. The system 720 automatically will rebuild the data in the new structure. The Manage server 728 may also or alternatively dynamically determine a new or revised data structure for the database, stream view and/or a new stream view and identify or suggest a new stream view that is optimized or otherwise configured to improve the operation of the one or more database query. Thus, the dynamic data structures comprise a learning algorithm to constantly improve database performance, by matching data structures to the queries that are made of the database.

In contrast to a query optimizer, that optimizes or otherwise suggests or provides a different query, the manage server in this implementation is configured to alter or configure a new data structure (e.g., in the database or a stream view) to increase the speed, efficiency, or other operating parameter of a database command. This is done by creating one or more structures that match the queries being sent to the database cluster. In this manner, the actual data structure of a database or stream view is altered dynamically (or suggested dynamically) to improve one or more operating parameters of a database or stream view based on an analysis of one or more database queries. For example, where a particular query is repetitively received that fails to achieve a threshold or other requirement of a database (e.g., performed within a time threshold), a revised database structure may be determined that increases the performance of the database with respect to future iterations of that (or similar) database commands issued to the database and/or one or more stream views.

In various implementations of systems, such as the systems 700, 720 of FIGS. 7 and 8, for example, the sharded database system(s) (e.g., a sharded relational database) provide a scalable, high availability, recoverable (e.g., disaster recovery) system even in a situation where underlying infrastructure may not include scalable, high availability and/or recoverable components. The systems, in some implementations, may further provide consistent access and management for multiple database management system engines (e.g., SQL, NoSQL, NewSQL, In-Memory, etc.). The systems may also be configured to provide fast real-time analytic queries, operate with ad hoc analytics engines, provide real-time event processing (e.g., fire one or more automated events based on streaming data changes), and/or hands off automated management.

One or both of the systems shown in FIGS. 7 and 8, for example, may also provide automated cluster management, such as via a shard control language, a built-in version/deployment control, automated package management, server install and/or live schema changes; multi-domain support for combinations of a particular database management system and a sharding scheme; parser (e.g., full parser, parse-once architecture); stream view; indexing (e.g., recognize and shard based on a primary or other key); and advanced shard stripe sharding (e.g., to avoid or minimize re-sharding and/or add servers without re-sharding).

Replication in systems, such as systems 700, 720 shown in FIGS. 7 and 8, may also be done in accordance with many different replication techniques. In one particular implementation, for example, a replication technique such as one disclosed in U.S. Pat. No. 8,626,709 issued to Cory Isaacson and Andrew Grove on Jan. 7, 2014, which is hereby incorporated by reference in its entirety as if fully set forth herein, may be used. Other replication techniques may also be used. In another implementation, a collection of reliable replication servers are used to ensure replicate messages are fault tolerant, and can then be applied in parallel to one or more database servers. In various implementations, for example, continuous replication including a true “active-active” operation may be provided. Further, automated and/or planned failover may be provided.

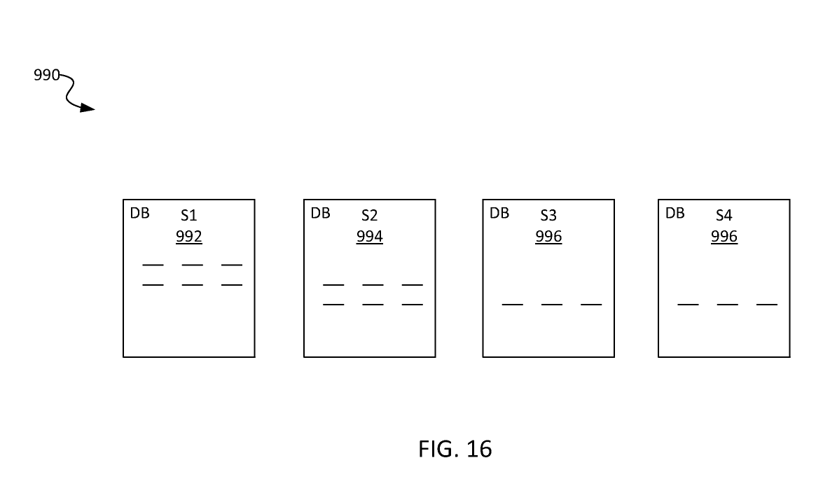

Further, advanced sharding techniques, such as shard stripes may be used to eliminate minimize re-balancing. In one implementation, for example, shard striping may work with a monotonic shard key and a consistent hash and/or an arbitrary shard key and consistent hash. An example of shard stripes is provided below with reference to FIG. 16.

In one implementation, data is written to a reliable replication or transaction log as the first step. This stores the actual data, including new, updated or deleted data in a single message in the reliable collection of replication servers (StreamEngine). The data is marked by a position within a shard, micro-shard, and file, such that it can be accessed rapidly when required after writing. In other implementations, this can be done by a sequence number of transactions within the stream, or other unique identifier. This is called the data producer stream. One or more data consumers subsequently read the data stream for one shard, micro-shard, or a collection of shards or micro-shards. The consumer then performs any operations on the data required to construct a dynamic data structure, or modify data within an existing dynamic data structure. The dynamic data structures are the stream views (StreamView) in this implementation.

In a specific implementation of the stream engine, network multiplexing, sharding, micro-sharding, and reliability are combined to provide efficiency and reliability in writing to the stream. Network multiplexing sends one or more data messages to the stream in a batch, and subsequently receives a batch of acknowledgements in return, indicating that the data has been written to the stream successfully and reliably. The data producer can write to one or more shards or micro-shards within the stream for portioning of the data. The reliability is provided by writing any stream message to at least two stream engine servers before acknowledging the write to the client.

A particular type of data in the stream may produce multiple stream views; each organized to optimize a specific query or queries. The stream view is distributed based on an optimized (or improved) pattern to provide improved performance for various application queries. This implementation ensures that all data is reliable, as the stream engine creates multiple copies of the data for each write. The processing of data by stream consumers into stream views can be performed in an asynchronous basis (i.e., the client does not wait for the stream view to be updated), or can be performed on a synchronous basis (i.e., the client does wait for the stream view to be updated). Each stream view maintains its position, for example, based on a last-acknowledged offset to an incoming log.

The system supports concurrent reads from the database, even if asynchronous updates to stream views are used. This is done by a) reading the data requested by the query from the stream view; b) reading the stream view position within the stream; and c) appending or applying any additional data that may reside in the stream that has not yet been applied to the stream view.

A stream view is comprised of a collection of one or more maps, which are data structures used to create a dynamic data structure. The maps are key-value pairs, or lists of data, and can be organized using any number of facilities provided for data storage optimization. These facilities can include indexes, customized views of the data, bitmap indexes, and column store formats. Thus a stream view can be created from one or more maps, each with a specific type of internal data structure, matching the needs of the application as closely as possible.

Dynamic changes to data structures (automated or suggested) can be used to provide a dynamic database and/or stream views for executing database commands in a relatively efficient manner. In many situations, for example, a database is not static, but rather is dynamic in which data and usage patterns change over time and new requirements for the database emerge. In the present application, various techniques are provided to dynamically change and/or suggest changes to the database or stream view data structure(s) for matching an application over time. The generated data structures can also be sharded (partitioned) to allow for scaling across many replication or shard servers, determining an optimized partitioning scheme that matches the application usage of the database based on query analytics as described above. Thus, existing data structures may be modified, dropped and/or replaced and new data structures added. Thus, flexible data structures as described herein can be designed to meet one or more needs one or more applications. A dynamic engine can be designed around Big Data streaming with built-in, automated scalability and reliability. In various implementations, for example, one or more components of the database may monitor a stream of database queries or transaction logs to provide the dynamic adjustment of data structures.

In one implementation, for example, one or more database structures, such as relational sharding, micro-sharding, partitioned data, partitioned indices or other data structures may be restructured on the fly (or database restructuring suggested for review by a database manager). For example, data structures and partitioning of data structures of the database or stream views may be restructured to increase or optimize single shard actions relative to multi-shard actions from database queries received. A database shard stream, in one implementation, for example, may analyze a database shard stream, summarize, aggregate or otherwise process information from the stream and then optimize one or more data structures of the database and/or shard streams. Thus the application requirements can be matched more closely, providing optimized performance and efficiency of the database system.

In one particular implementation, the analysis and/or revised programmatic code to access dynamic database structures can be performed at various locations/levels of a database system to increase the operational efficiency of the operations. These will be stored as compiled low-level access procedures, to perform one or many operations required to read from or write to a dynamic database structure. The procedure code to access dynamic database structures, for example, may be located (e.g., compiled into object code) to run on a processor co-located with a drive of a database. In one particular implementation, the procedure code algorithms (e.g., aggregation, vector processing, etc.) may be loaded into custom gate arrays in the chip itself, such as at an FPGA chip located at a particular component of a database system where the data structure is to be stored. Compiling, for example, may be implemented via a script, such as javascript, or other scripts to generate or alter a data structure on the fly.

The dynamic procedure algorithm used to access a dynamic data structure, for example, comprises a group of multiple database operations, such as, the following:
a multi-step write command;
a multi-step read command;
a distributed write command; and
a distributed read command.
   Performing multiple database operations through a single compiled procedure executing at the processor on the drive, or compiled into the processor on the drive, for the purpose of reading from, writing to, or performing a distributed operation to a dynamic data structure, eliminates multiple step invocations to the drive from the operating system. There are many layers between an operating system and a drive in a typical implementation, thus this approach has many fewer steps. Only one call to invoke a procedure to the processor on the drive is required, to perform all steps within the procedure in the drive itself.

Heuristics may also be used to analyze monitored queries from one or more database streams to determine a dynamic database structure in response to information included in a monitored database stream. In this way, any number of potential dynamic database structures can be evaluated in order to find the best performing option to satisfy queries from the stream.

Monitoring a database stream may be used to determine an optimized data structure, such as by monitoring one or more queries that are repetitively submitted to one or more databases (e.g., shard, micro-shards or other portions of the database).

Micro-shards may also be used along with parallel replication and/or parallel processing of database operations.

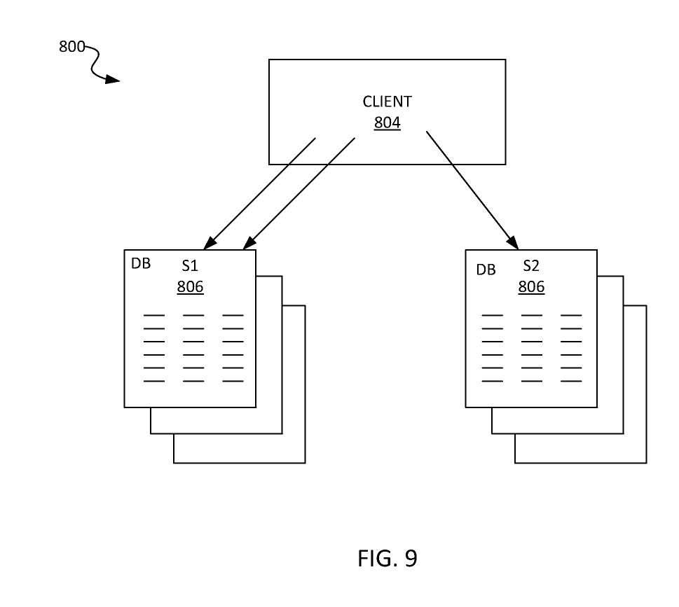

FIG. 9 shows a block diagram of an example database stream 800 in which one or more database commands 802 are received from a client application 804. The database commands 802 are received at a database 806 (e.g., the sharded database 806 shown in FIG. 9) and are analyzed at the database 806.

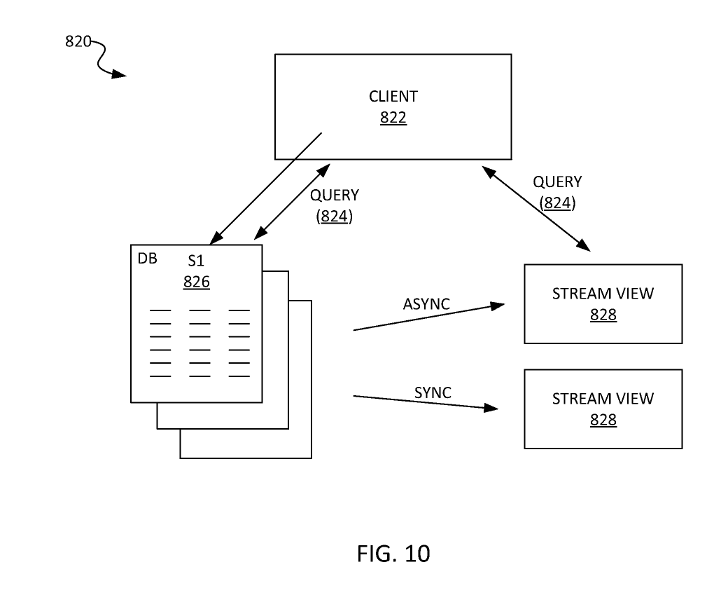

FIG. 10 is a block diagram showing yet another example of a sharded database system 820 in which database query commands from a client 822 are directly provided to a database 826 and/or to a stream view 828 generated synchronously and/or asynchronously from the database as described herein. In FIG. 10, for example, database query commands 824 from the client 822 may be directly provided to the database 826 and/or to a stream view 828 generated synchronously and/or asynchronously from the database 826.

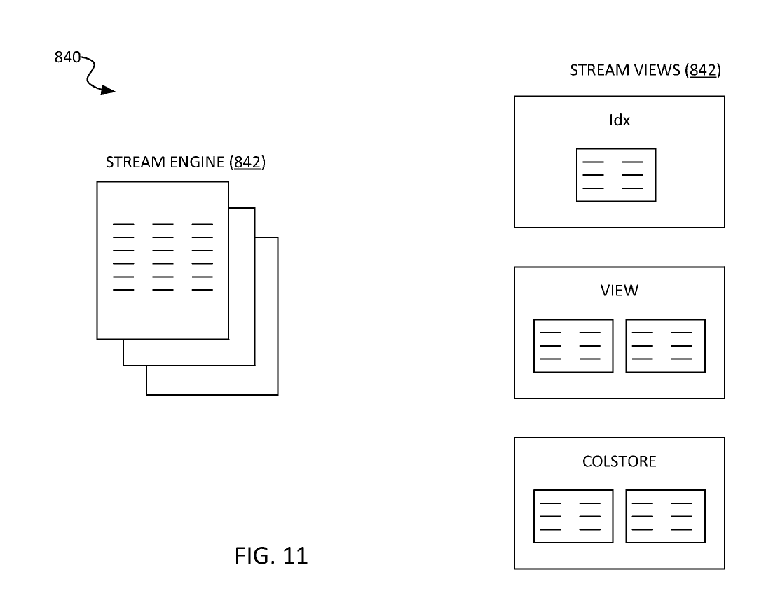

FIG. 11 shows an example implementation of a stream engine 840 that monitors and analyzes one or more database commands of a database as discussed herein. In this implementation, the stream engine 840 can monitor database commands directed to the database 842 and/or one or more stream views 844 (e.g., Idx, View and Colstore in this particular implementation).

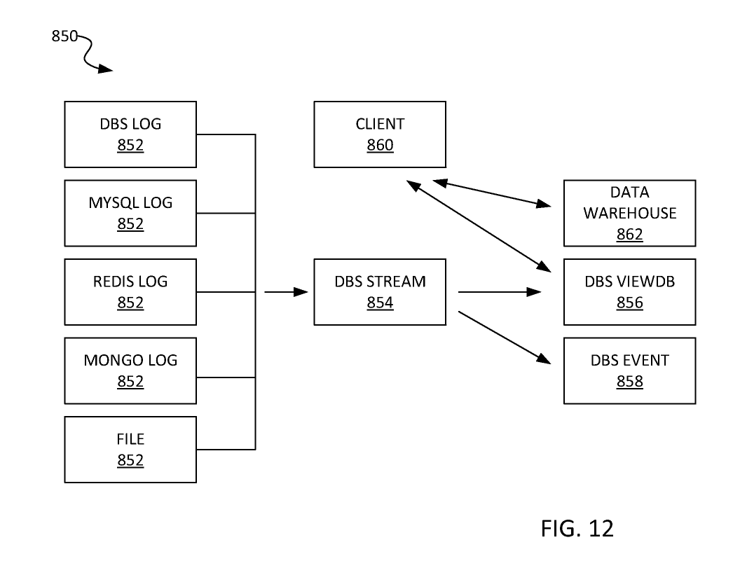

FIG. 12 shows yet another example implementation of a database system 850 in which one or more log files 852 (e.g., replication logs) provide a database stream 854 for analysis. Analysis of the database stream 854, for example, may be analyzed via a database viewer (e.g., dbS Viewdb 856) and/or a database event module (e.g., dbS Evebt 858). The database viewer 856, for example, may in some implementations provides a pluggable view engine, such as a MapDB wrapper layer. An event database, for example, may store information about view events as records in a database. Further, a database client 860 may communicate with a data warehouse 862 and the database viewer 856 and provide information between the data warehouse 862 and the database viewer 856.

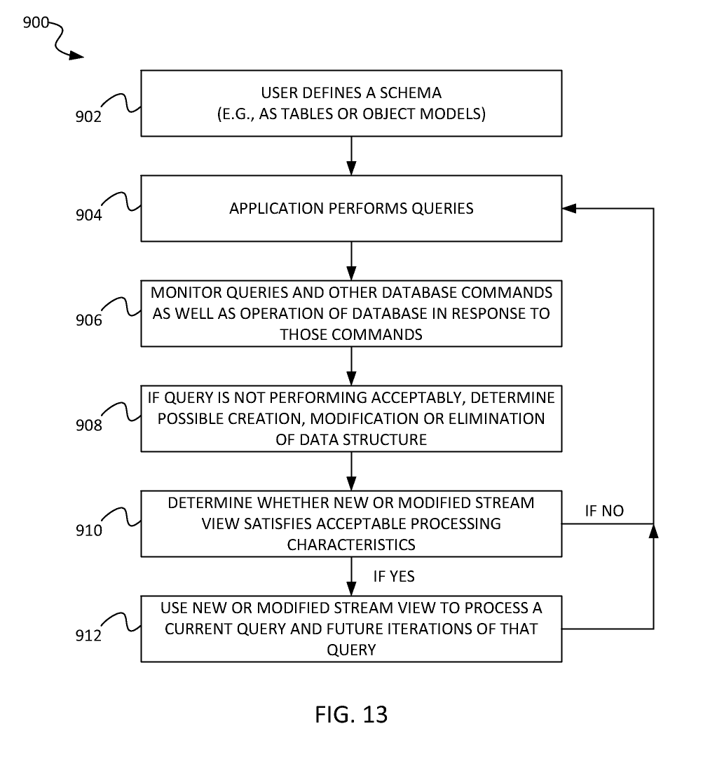

FIG. 13 shows one example of an example process 900 of dynamically monitoring operation of a database system and modifying data structures (or suggesting modifications to data structures) in the database in response to database commands, such as queries, received at the database from a client. In this process, one or more stream views can be linked to original table definitions of a database and can be used to derive which of a plurality of stream views is best or capable of handling a given database query command. The system (e.g., in a console server) can keep track of which table a stream view comes from, and then evaluate other characteristics such as, but not limited to, is the view summarized data or detail data, is it pre-joined to other tables or independent from other tables, if it is summarized, at what level or interval, and does that level or interval satisfy the query command? The understanding of particular data, its origin table definitions and stream view definitions allows the database system to understand a “chain” of how the data is manipulated to that it can best or efficiently match stream views and queries.

In this example process, a user defines a schema as tables or object models in operation (1). An application performs queries in operation 902. An application client, such as shown in FIGS. 7 and 8, for example, performs database queries and submits other commands to a database in operation 904. In operation 906 a console server or other monitoring component of the database system monitors the queries and other database commands as well as operation of the database in response to those commands.

If a particular query (e.g., a repetitive query submitted to the database in a stream of database commands) is not performing well (e.g., failing to be performed within a predetermined threshold range of response times or the like), the console server evaluates statistics such as by using heuristics, algorithms or other analytical techniques to create, modify or eliminate a stream view data structure in operation 908.

Where a particular query is not efficiently obtaining a result from a database, for example, a console server can use heuristic algorithms or other techniques to evaluate the query and the existing database structure. The console server can then determine a modified or new data structure of a stream view for optimally handling the repetitive query via a new or modified stream view. If an existing stream view is no longer warranted, such as due to changing database data, conditions or other factors, the out of date stream view may also be eliminated. If a new or modified stream view is determined to satisfy acceptable processing characteristics, it is used in operation 912 to process the query and future iterations of that query (or suggested as a possible data structure modification for future implementation).

In some implementations of the process, the process can be implemented in a cyclical manner so that after completion of operation 312 where a new stream view is defined and used or after an existing stream view is modified ad used or discarded, the process can loop back to operation 904 to monitor new queries. In other implementations multiple processes can be performed in parallel or in series.

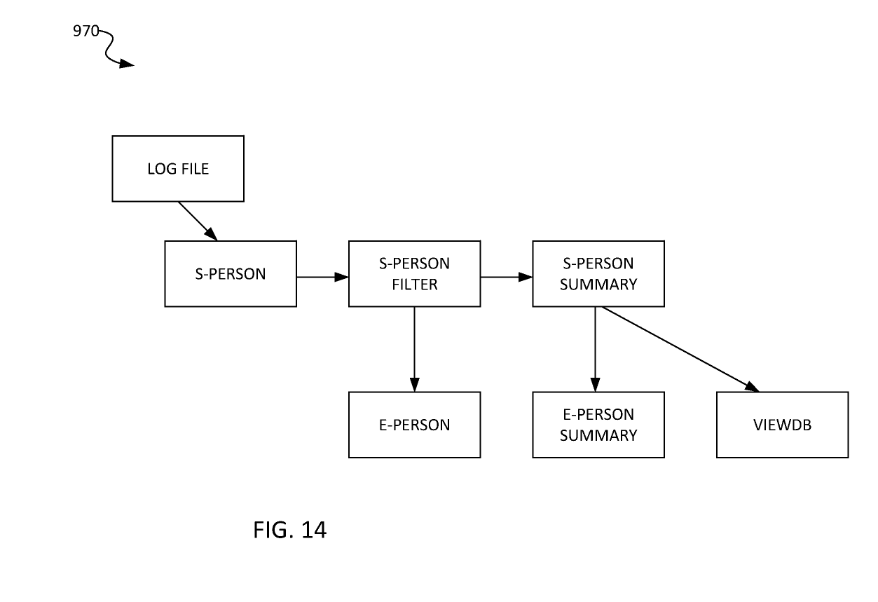

FIG. 14 is a block diagram illustrating example functions 970 applied to a stream of database commands. In this example implementation, for example, a viewer Viewdb provides continuously updated snapshots of the updated stream output of the functions. The functions shown in FIG. 14 are merely examples and can be implemented in a variety of contexts, languages or the like.

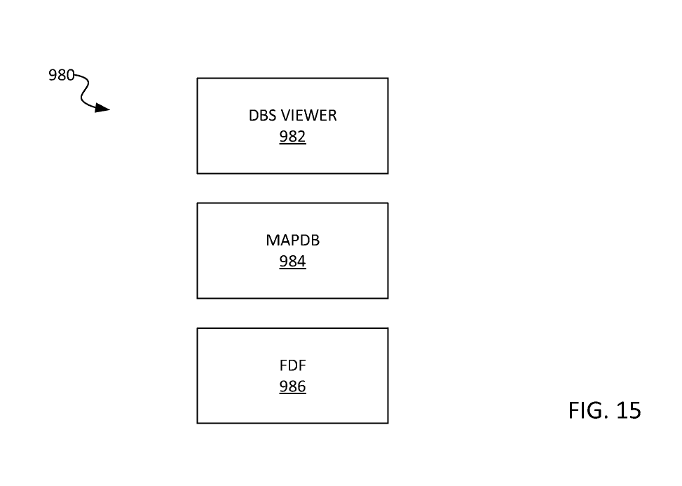

FIG. 15 is a block diagram illustrating an example pluggable view engine Viewdb 280 that may be used to provide one or more (e.g., continuously updated) snapshots of a database stream as described herein. In the particular implementation shown in FIG. 15, for example, the view engine 980 includes examples of MapDb and Forms Data Format (FDF) viewers, although other view engine implementations are also contemplated.

FIG. 16 is a block diagram illustrating an example implementation of a sharded database structure 990 using a shard stripe approach across a plurality of databases (e.g., across databases S1 992, S2, 994, S3 996 and S4 998 shown in FIG. 16). In the implementation shown in FIG. 16, for example, a shard stripe approach provide for eliminating, minimizing or at least reducing re-balancing that may otherwise be needed in a database. In this implementation, shard stripe data structures are used. The shard stripe structure, in various implementations, work with a monotonic shard key and a consistent hash and/or an arbitrary shard key and consistent hash.

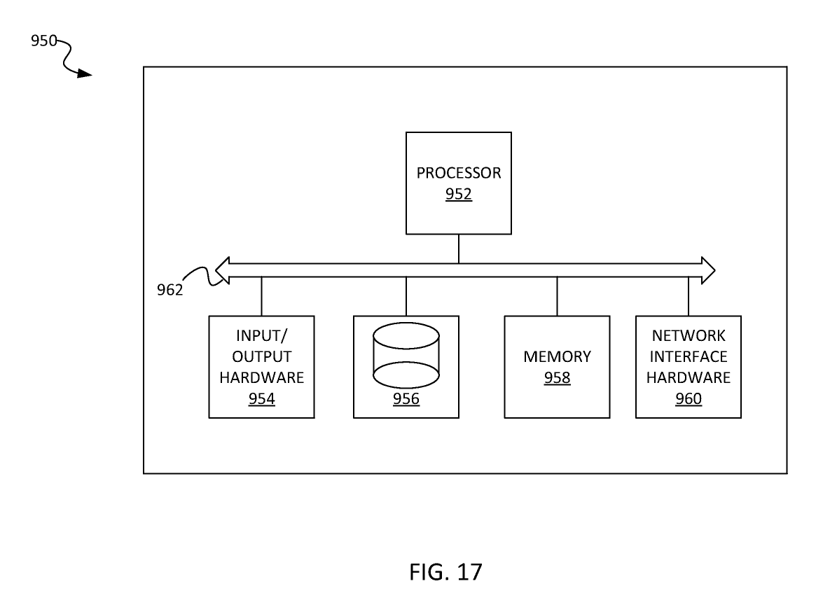

FIG. 17 is a block diagram illustrating an example computing device 950, such as a server or other computing device, on which one or more database shards of a sharded database may reside in whole or in part.

In one particular implementation, for example, the server 950 comprises a processor 952, input/output hardware, a non-transitory computer readable medium 954 configured to store data of a database, a non-transitory memory 956, network interface hardware 960. Each of these components are operably coupled via a local interface 962, which may be implemented as a bus or other interface to facilitate communication among the components of the server 950.

The non-transitory computer-readable medium component 956 and memory 958 may be configured as volatile and/or nonvolatile computer readable medium and, as such, may include random access memory (including SRAM, DRAM, and/or other types of random access memory), flash memory, registers, compact discs (CD), digital versatile discs (DVD), magnetic disks, and/or other types of storage components. Additionally, the non-transitory computer readable medium component 956 and memory component 958 may be configured to store, among other things, database data, analysis and/or revised programmatic code to access dynamic database structures. The analysis and/or revised programmatic code to access dynamic database structures, for example, can be performed at various locations/levels of a database system to increase the operational efficiency of the operations. In one particular implementation, for example, the analysis and/or revised programmatic code to access dynamic database structures may be stored as compiled low-level access procedures, to perform one or many operations required to read from or write to a dynamic database structure. The procedure code to access dynamic database structures, for example, may be located (e.g., compiled into object code) to run on a processor, such as the processor 952, co-located with a drive of a database. In one particular implementation, the procedure code algorithms (e.g., aggregation, vector processing, etc.) may be loaded into custom gate arrays in the chip itself, such as at an FPGA chip located at a particular component of a database system where the data structure is to be stored. Compiling, for example, may be implemented via a script, such as javascript, or other scripts to generate or alter a data structure on the fly.

The processor 952 may include any processing component configured to receive and execute instructions (such as from the memory component 958). The input/output hardware 954 may include any hardware and/or software for providing input to computing device 950, such as, without limitation, a keyboard, mouse, camera, sensor, microphone, speaker, touch-screen, and/or other device for receiving, sending, and/or presenting data. The network interface hardware 954 may include any wired or wireless networking hardware, such as a modem, LAN port, wireless fidelity (Wi-Fi) card, WiMax card, mobile communications hardware, and/or other hardware for communicating with other networks and/or devices.

It should be understood that the memory component 958 may reside local to and/or remote from the computing device 950 and may be configured to store one or more pieces of data for access by the computing device 950 and/or other components. It should also be understood that the components illustrated in FIG. 17 are merely exemplary and are not intended to limit the scope of this disclosure. More specifically, while the components in FIG. 17 are illustrated as residing within the computing device 950, this is a non-limiting example. In some implementations, one or more of the components may reside external to the computing device 950, such as within a computing device that is communicatively coupled to one or more computing devices.

Although implementations of this invention have been described above with a certain degree of particularity, those skilled in the art could make numerous alterations to the disclosed implementations without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of processing in a database system, the method comprising:
transforming data from one or more source databases into at least one stream of data;
coupling the at least one stream of data to at least one stream processing node for processing; and
processing the at least one stream of data at the at least one stream processing nodes.

2. The method of claim 1 wherein one or more processing results from the at least the one stream processing nodes are stored in a database view.

3. The method of claim 2 wherein the database view comprises a database view of data from at least one stream of database data organized by a different key or other data structure than the source database or data.

4. The method of claim 2 wherein the database view comprises a result of processing operations performed on data from the at least one stream of data.

5. The method of claim 2 wherein the database view is persistent and query-able.

6. The method of claim 2 wherein the database view is exposed external to the database wherein the database view is replicated, at least in part, to an external database target.

7. The method of claim 1 wherein the operation of transforming data includes pulling data from the one or more source databases.

8. The method of claim 1 wherein the operation of transforming data includes pushing data from the one or more source databases.

9. The method of claim 1 processing is real-time, near-real-time, asynchronous

10. The method of claim 1 wherein a schema optimizer is configured to identify and select or recommend at least one view to match at least one need of an application.

11. The method of claim 1 wherein a query optimizer is configured to identify at least one view as a source of data for a query.

12. The method of claim 1 wherein at least one stream processing node is implemented on a DBoD comprising a processor, a memory, non-volatile data storage and a communications interface, wherein at least one stream of data is received via the communications interface.

13. The method of claim 12 wherein at least one processing result is stored as a database view in the non-volatile storage of the DBoD.

14. The method of claim 12 wherein at least one processing result is stored as a database view on a non-volatile data storage of a DBoD comprising a processor, a memory, the non-volatile data storage and a communications interface.

15. The method of claim 1 wherein the operation of processing the at least one stream of data comprises a plurality of processing steps occurring in a plurality of different stream processing nodes, wherein each of the plurality of different stream processing nodes are implemented on a plurality of different DBoDs each comprising a processor, a memory, a non-volatile data storage and a communications interface and wherein each of the plurality of DBods are coupled to each other via the respective communications interfaces of the plurality of DBoDs.

16. The method of claim 15, wherein the communications interfaces of the plurality of DBoDs comprises Ethernet interfaces.

17. The method of claim 15 wherein the plurality of different DBoDs are coupled to a application client in a one to many configuration.

18. The method of claim 17 wherein the application client is implemented on another DBoD including a processor, a memory, a non-volatile data storage and a communications interface.

18. The method of claim 15 wherein the plurality of different DBoDs are coupled to a plurality of application clients in a many to many configuration.

20. The method of claim 19 wherein each of the application clients is implemented on another DBoD including a processor, a memory, a non-volatile data storage and a communications interface.

21. A method of processing data in a database system, the method comprising:
writing a record to a database in an append-only log file;
indexing the append-only log file;
referencing a history of at least one version of an index structure, such as a key, if the record exists in the database with the same index structure;
look up the record in the database by index structure of the append-only log file; and
exposing an ordered queue including an order in which transactions were written in addition to using an index structure look up.
